(19) United States
(12) Patent Application Publication
(10) Pub. No.: US 2024/0421745 A1
(43) Pub. Date: Dec. 19, 2024

(54) ELECTRIC MOTOR

(71) Applicant: Dyson Technology Limited, Wiltshire (GB)

(72) Inventors: Adrián ARTACHO LÓPEZ, Newcastle upon Tyne (GB); Daniel James Bernard SMITH, Newcastle upon Tyne (GB); Barrie Charles MECROW, Newcastle upon Tyne (GB)

(21) Appl. No.: 18/701,442

(22) PCT Filed: Oct. 17, 2022
(86) PCT No.: PCT/GB2022/052634

§ 371 Date: Apr. 15, 2024

(30) Foreign Application Priority Data
Oct. 20, 2021 (GB) 2115010.7

(51) Int. Cl. H02P 29/50

(52) U.S. Cl. CPC H02P 29/50; H02P 2207/05

(57) ABSTRACT

An electric motor is provided that includes a rotor, a stator, and a filter. The stator includes a stator core and windings. The filter is a magnetic low-pass filter including a coil having one or more turns and one or more capacitors connected in series with the coil. Excitation of the windings generates stator flux, the coil is linked to the stator flux, and the filter attenuates harmonics in the stator flux.

### FIELD OF THE INVENTION

The present invention relates to an electric motor.

### BACKGROUND OF THE INVENTION

In an electric motor, changes in magnetic flux may induce eddy currents in the rotor and the stator. These eddy currents generate resistive losses that can significantly impact the efficiency of the motor.

### SUMMARY OF THE INVENTION

The present invention provides an electric motor comprising: a rotor, a stator comprising a stator core and windings; and a magnetic low-pass filter comprising a coil having one or more turns and one or more capacitors connected in series with the coil, wherein excitation of the windings generates stator flux, the coil is linked to the stator flux, and the filter attenuates harmonics in the stator flux.

By attenuating harmonics in the stator flux, the magnitude of eddy currents induced in the rotor may be reduced. As a result, a reduction in rotor loss and/or torque ripple may be achieved. Alternatively, a similar rotor loss may be achieved using a cheaper, more lossy rotor (e.g. cheaper, more lossy laminations).

The rotor may comprise one or more magnets. Eddy currents induced in the magnets can lead to excessive heating and demagnetization of the magnets. By attenuating harmonics in the stator flux, the magnitude of the eddy currents induced in the magnets may be reduced. As a result, excessive heating and demagnetisation of the magnets may be avoided.

A conventional electric motor may comprise conductive shielding that is placed on or around each of the magnets of the rotor. The shielding is non-discriminatory and attenuates the stator flux across all frequencies. Consequently, whilst the shielding provides effective protection to the magnets, the resulting power losses can be high.

The applicant has observed that, whilst the total magnet loss for bare magnets (i.e. without shielding) can be high, the magnet loss at relatively low frequencies can be low. By contrast, the losses in the shielding can be significant even at lower frequencies. The present invention therefore employs a magnetic low-pass filter that filters (i.e. strongly attenuates) higher frequencies in the stator flux but passes (i.e. weakly attenuates) lower frequencies. As a result of passing the lower frequencies, power losses in the filter are lower than those in the shielding. As a corollary, power losses in the magnets are higher. However, the increase in magnet loss may be relatively modest, and may be reduced by magnet segmentation, where a lesser degree of segmentation may be employed in comparison to bare magnets. Moreover, the increase in the magnet loss may be more than offset by the decrease in the filter loss. As a result, a net gain in total power loss may be achieved.

The filter may have a resonant frequency greater than a running frequency of the motor. The running frequency corresponds to the electrical frequency of the rotor during normal operation of the motor. Should the rotor operate over a range of speeds during normal operation, the running frequency may correspond to the electrical frequency of the rotor when rotating at a nominal speed or at a maximum speed within the speed range. The stator flux may have a fundamental frequency at the running frequency of the motor. Lower order harmonics in the stator flux may contribute significantly to filter loss. However, these lower order harmonics, which have relatively low frequencies, may not contribute significantly to rotor and/or magnet loss. Accordingly, by ensuring that the resonant frequency of the filter is greater than the running frequency, the filter loss may be reduced.

The resonant frequency may be at least twice that of the running frequency. This then ensures that the frequency range over which the filter behaves resistively is sufficiently far removed from the running frequency. As a result, excessive currents in the filter due to lower order harmonics in the stator flux may be avoided.

An impedance of the filter at the running frequency may be at least ten times an impedance of the filter at the resonant frequency. The impedance of the filter may therefore be relatively high at lower order harmonics and thus excessive currents may be avoided.

The filter may have a resonant frequency less than a switching frequency of the windings, i.e. the switching frequency of the inverter to which the windings are coupled. Since the switching frequency is typically high, harmonics at this frequency, if not filtered, may contribute significantly to the rotor and/or magnet loss. By ensuring that the resonant frequency of the filter is less than the switching frequency, harmonics in the stator flux at the switching frequency may be attenuated and thus the rotor and/or magnet loss may be reduced.

An impedance of the filter at the switching frequency may be no more than five times an impedance of the filter at the resonant frequency. As a result, in spite of the increase in impedance as one moves from the resonant frequency, effective attenuation of harmonics in the stator flux at the switching frequency may nevertheless be achieved.

An impedance of the filter at a running frequency of the motor may be at least three times an impedance of the filter at a switching frequency of the motor. Lower order harmonics in the stator flux have relatively low frequencies and are therefore unlikely to contribute significantly to the magnet loss, unless their magnitude is similar to that of the running frequency. By contrast, the switching frequency is typically high and therefore harmonics in the stator flux at this frequency may contribute significantly to the magnet loss despite their relatively low magnitudes.

By ensuring that the filter has a higher impedance at the running frequency, lower order harmonics in the stator flux may be passed (i.e. weakly attenuated), whilst the lower impedance at the switching frequency may ensure that harmonics in the stator flux at this frequency are filtered (i.e. strongly attenuated).

The filter may be mounted to the rotor. This then has the benefit that the filter rotates synchronously with the rotor and the fundamental stator flux (as well as the magnet flux of the rotor, should the rotor comprise magnets). The filter does not therefore interact with these fluxes and thus the filter loss may be reduced. By contrast, if the filter were mounted to the stator, the filter would interact with these fluxes and thus the filter loss may be higher.

Where the rotor comprises one or more magnets, each of the magnets may be segmented (either fully or partially) and comprise a plurality of magnet segments. By segmenting the magnets, the electrical resistance of each of the magnets is increased. As a result, magnet loss may be further reduced due to the lower eddy currents induced by the lower frequency harmonics. Segmentation, however, increases the surface area of each of the magnets. Consequently, in the absence of the filter, segmentation may actually result in a higher magnet loss due to the skin effect at higher harmonic frequencies. By employing a magnetic low-pass filter, the relatively high harmonic frequencies that might otherwise present a problem may be attenuated. A synergistic effect is therefore achieved in employing a magnetic low-pass filter together with a segmented magnet. In particular, the magnetic low-pass filter filters higher frequency harmonics in the stator flux but passes lower frequency harmonics, and segmentation of the magnet reduces eddy currents at lower frequency harmonics. As a result, a net reduction in the power loss may be achieved.

The electric motor may comprise a filter for each magnet. By providing a filter for each magnet, harmonics in the stator flux linked to each magnet may be more effectively attenuated and thus the magnet loss may be further reduced.

The coil of the filter may be wound about the magnet. This then has the advantage that, should the magnets be embedded within the rotor core, the coil may be located conveniently within the same cavity as the magnet. Alternatively, should the magnets be mounted to a surface of the rotor core, the coil may be conveniently located around the magnet. A further advantage is that, in winding the coil about the magnet, the filter is linked to and attenuates the stator flux that links with the magnet, whilst minimising its link to other stray fluxes that do not contribute to magnet loss but would add loss in the filter. As a result, effective protection of the magnets may be provided without additionally, unnecessary losses in the filter.

The capacitors may be located within a cavity in the rotor or the stator. As a result, a relatively compact arrangement may be achieved. The cavity may be provided to accommodate the magnets or to better shape the path of the flux through the rotor or stator. By locating the capacitors within such a cavity, a relatively compact arrangement may be achieved without adversely affecting the performance of the motor.

The filter may comprise a plurality of capacitors located within the cavity. By employing a plurality of capacitors, a given capacitance may be achieved for the filter using capacitors that are physically smaller. As a result, the capacitors may be located in a relatively compact way within an existing cavity without adversely affecting the performance of the motor. For example, the capacitors may be arranged as an array along the length of the cavity.

The filter may be passive. As a result, high frequency harmonics in the stator flux may be filtered in a relatively simple and cost-effective manner. In particular, high frequency harmonics may be attenuated using a filter that is unpowered and has a relatively large frequency range.

### BRIEF DESCRIPTION OF THE DRAWINGS

FIG. 1 is a section view of an electric motor;

FIG. 2 is an expanded view of part of the section of FIG. 1;

FIG. 3 is a simplified schematic circuit of the electric motor;

FIG. 4 is a graph illustrating the impedance and the induced current of a filter of the electric motor for a given flux;

FIG. 5 is a table detailing the power losses in an example electric motor having one of bare magnets, shielding, and filters; and

FIG. 6 is a section view of part of the electric motor detailing alternative positions for a coil of the motor.

### DETAILED DESCRIPTION OF THE INVENTION

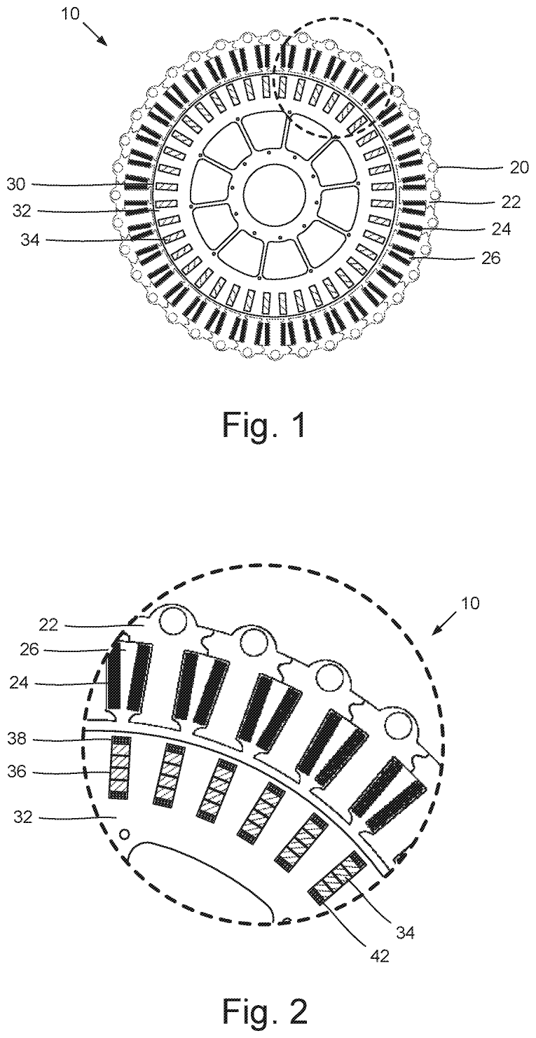

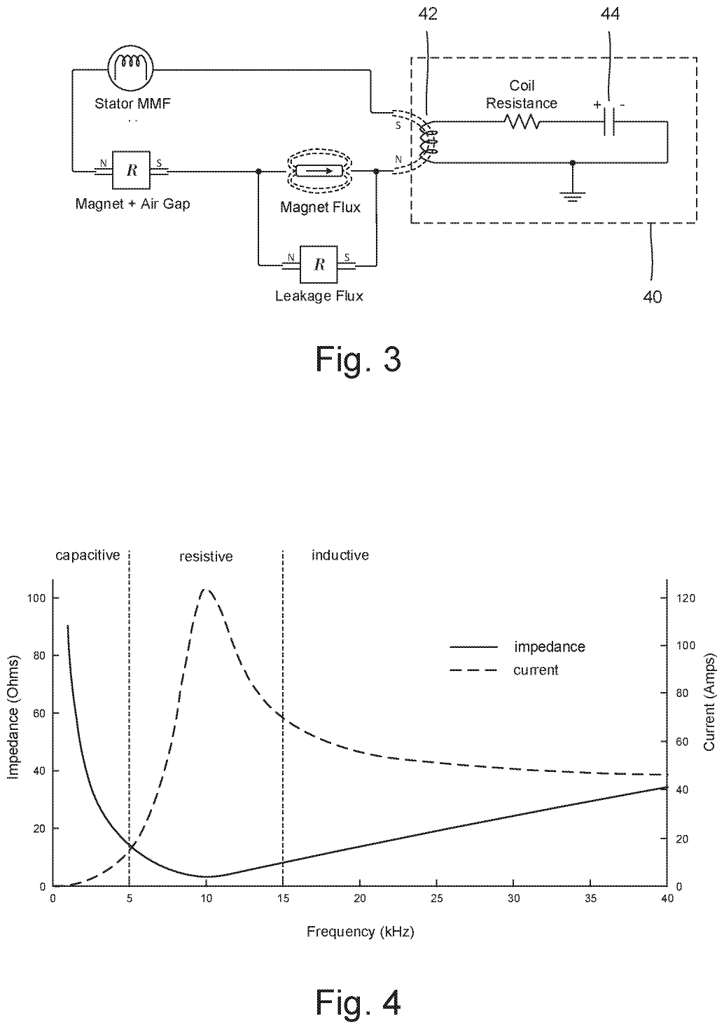

The electric motor 10 of FIGS. 1 to 3 comprises a stator 20, a rotor 30, and a plurality of filters 40.

The stator 20 surrounds the rotor 30 and comprises a stator core 22 and a plurality of windings 24. The stator core 22 comprises a plurality of slots 26 into which the windings 24 are located.

The rotor 30 comprises a rotor core 32 and a plurality of magnets 34. The rotor core comprises a plurality of cavities 36 into which the magnets 34 are mounted. Each magnet 34 is segmented both radially and axially. As a result, each magnet 34 comprises a plurality of magnet segments. Each magnet 34 is mounted within a respective cavity 36 in the rotor core 32. The cavity 32 is slightly longer (radially) than the magnet 34. As a result, an air pocket 38 is created at each end of the cavity 32. The air pockets 38 act to better shape the flux through the rotor 30.

Each of the filters 40 comprises a second order filter having a coil 42 connected in series to a capacitor 44. A filter 40 is provided for each of the magnets 34 of the rotor 30. The coil 42 of each filter 40 comprises one or more turns that are wound about a respective magnet 34. In this particular embodiment, the capacitor 44 comprises a plurality of smaller capacitors (not shown) that are connected in parallel to provide the required capacitance, and which are located, together with the coil 42, within the respective cavity 36 of the rotor core 32. This then has the advantage of providing a relatively compact arrangement. In particular, the coil 42 and the capacitor 44 are located within the existing air pockets 38 in the rotor core 32. In alternative embodiments, the capacitor 44 may be located at an end of the rotor core 32 and thus outside of the cavity 36.

During operation of the electric motor 10, the windings 24 of the stator 20 are excited with a voltage. The excitation of the windings 24 generates a magnetic flux (referred to hereafter as stator flux), which interacts with the magnetic flux of the magnets 34 (referred to hereafter as rotor flux) to generate torque. The voltage applied to the windings 24 is switched or commutated so as to create a rotating stator field. The voltage applied to the windings 24 may be switched such that the stator flux is generally sinusoidal or trapezoidal in shape. However, the stator flux is not perfectly sinusoidal or trapezoidal but instead comprise other frequencies or harmonics. In particular, the stator flux comprises both space and time harmonics.

Space harmonics arise from, among other things, the physical position of the windings 24, the slots 26 in the stator core 22, asymmetry in the air gap, and rotation of the rotor 30. Time harmonics arise primarily from the electronics responsible for applying the voltage to the windings 24. Chief among these harmonics is that arising from the switching of the power switches of the inverter to which the windings 24 are coupled.

Harmonics in the stator flux induce eddy currents in the rotor 30. These eddy current generate resistive losses that are dissipated as heat. If unchecked, eddy currents induced in the magnets 34 can lead to excessive heating and demagnetization of the magnets 34. This is particularly true of sintered rare earth magnets, which have a relatively low resistivity (cf. bonded or ferrite magnets).

Shielding, such as an electrically conductive plate or coil, may be placed on or around each magnet. Currents induced in the shielding then generate an opposing magnetic field that attenuates the stator flux. As a result, lower eddy currents are induced in the magnets and thus the magnet loss is reduced. However, whilst the shielding may provide effective protection to the magnets, the resulting power loss in the shielding can be high. Indeed, the total power loss can be significantly higher than that without shielding.

The applicant has observed that, whilst the magnet loss for bare magnets (i.e. without shielding) can be significant, the magnet loss at relatively low harmonic frequencies is typically low. In contrast, losses in the shielding can be significant even at these lower frequencies. Each of the filters 40 is therefore designed to interact with the stator flux to filter (i.e. strongly attenuate) higher frequency harmonics whilst passing (i.e. weakly attenuating) lower frequency harmonics. As a result of passing the lower frequency harmonics, the power losses in the filter 40 are lower than those of equivalent shielding. As a corollary, the power losses in the magnets 34 are higher. However, the increase in the magnet loss is relatively modest and thus excessive heating of the magnets 34 may be avoided. Moreover, the increase in the magnet loss is more than offset by the decrease in the filter loss. As a result, a net gain in power losses may be achieved.

The coil 42 of each filter 40 is linked to the stator flux. Accordingly, currents induced in the filter 40 by the stator flux generate an opposing field that acts in opposition to and thus attenuates the stator flux.

Referring now to FIG. 4, each filter 40 may be said to have a capacitive region, a resistive region, and an inductive region. The capacitive region spans relatively low frequencies. The impedance of the filter 40 is relatively high over the capacitive region. As a result, the magnitude of the induced current for a given flux is relatively low. The filter 40 therefore provides relatively poor attenuation of the stator flux over the capacitive region, i.e. the filter 40 passes the lower frequency harmonics in the stator flux. The resistive region spans a range of frequencies centred at the resonant frequency of the filter 40. The impedance of the filter 40 is relatively low over the resistive region and is at a minimum at the resonant frequency. The filter 40 is therefore relatively sensitive to the stator flux over the resistive region. Consequently, the magnitude of the induced current for a given flux is relatively high and is at a maximum at the resonant frequency. The inductive region spans relatively high frequencies. The impedance of the filter 40 is higher than that over the resistive region but is nevertheless significantly lower than that over the capacitive region. The filter 40 therefore continues to be sensitive to the stator flux over the inductive region. However, for a given flux, the induced current is lower than that over the resistive region.

Each filter 40 therefore behaves as a magnetic low-pass filter. In particular, each filter 40 passes (i.e. weakly attenuates) lower harmonic frequencies in the stator flux whilst filtering (i.e. strongly attenuating) higher harmonic frequencies. It will be apparent from FIG. 4 that, from an electrical standpoint, the filter 40 does not operate as a low-pass filter. In particular, the current in the filter is filtered at lower frequencies and is passed at higher frequencies. Moreover, the magnitude of the current is at a maximum at the resonant frequency of the filter 40. Nevertheless, from a magnetic standpoint, the filter 40 behaves as a low-pass filter.

Each of the filters 40 may be tuned (i.e. the resonant frequency may be defined) through appropriate selection of the capacitance and inductance (e.g. number of turns) of the filter 40. The filter 40 may be tuned so as to minimize the total power loss whilst ensuring that the magnet loss does not exceed a threshold. For example, the filters 40 may be omitted and the magnitude of the harmonics in the stator flux may be measured during normal running of the motor 10. The measured harmonics may then be used to determine the resonant frequency of the filters 40 that results in the lowest overall power loss.

The electric motor 10 is synchronous and therefore the stator flux has a fundamental frequency at the running frequency of the motor 10, i.e. at the electrical frequency of the rotor 30 during normal running of the motor 10. Lower order harmonics in the stator flux may contribute significantly to filter loss. However, these lower order harmonics, which have relatively low frequencies, may not contribute significantly to the magnet loss. Accordingly, the filter 40 may be tuned so as to pass lower order harmonics in the stator flux. The filter 40 may therefore be tuned such that the resonant frequency of the filter 40 is greater than the running frequency of the motor 10.

The filter 40 may be tuned such that the resonant frequency is at least twice that of the running frequency. This then ensures that the frequency range over which the filter 40 behaves resistively (i.e. the resistive region of FIG. 4) is sufficiently far removed from the running frequency. Alternatively or additionally, the filter 40 may be tuned such that impedance of the filter 40 at the running frequency is at least ten times the impedance at the resonant frequency. As a result, the current induced in the filter 40 from lower order harmonics in the stator flux may be kept relatively low.

The motor 10 may operate at a constant speed following acceleration, and the running frequency of the motor 10 may correspond to the electrical frequency of the rotor 30 when operating at the constant speed. Alternatively, the motor 10 may operate at a nominal speed, but have brief excursions to higher or lower speeds. In this instance, the running frequency of the motor 10 may correspond to the electrical frequency of the rotor 30 when operating at the nominal speed. Although higher currents may then be induced in the filter 40 when the motor 10 operates at speeds higher than the nominal speed, the higher speeds are transient and therefore a significant increase in filter loss may be avoided. In a further alternative, the motor 10 may operate over a range of speeds during normal running. In this instance, the running frequency of the motor 10 may correspond to the electrical frequency of the rotor 30 when operating at the maximum speed.

The stator flux may have a high harmonic content at the switching frequency of the motor 10, i.e. at the switching frequency of the inverter to which the windings 24 are coupled. The switching frequency is typically high. As a result, harmonics at this particular frequency, if not attenuated, may contribute significantly to the magnet loss. Accordingly, the filter 40 may be tuned so as to filter harmonics at this particular frequency. In particular, the filter 40 may be tuned such that the resonant frequency of the filter 40 is less than the switching frequency. Moreover, the impedance of the filter 40 at the switching frequency may be no more than five times the impedance at the resonant frequency. As a result, effective attenuation of harmonics in the stator flux at this particular frequency may be achieved. The filter 40 may be tuned such that the switching frequency lies within the inductive region of the filter 40. As a result, harmonics in the stator flux at this frequency may be attenuated without excessively high currents.

As with the running frequency, the switching frequency may be constant during normal running of the motor 10. Alternatively, the windings 24 may be switched at a nominal switching frequency, but then switched briefly at higher or lower frequencies as required. In this instance, the filter 40 may be tuned with respect to the nominal switching frequency. In a further alternative, the windings 24 may be switched over a range of switching frequencies during normal running. In this instance, the filter 40 may be tuned with respect to the minimum switching frequency.

For reasons outlined above, the filter 40 may be tuned such that lower order harmonics in the stator flux are passed, whilst harmonics at the switching frequency of the motor 10 are filtered. To this end, the impedance of the filter 40 at the running frequency may be at least three times that at the switching frequency. The higher impedance at the running frequency then ensures that lower order harmonics are passed (i.e. weakly attenuated), whilst the lower impedance at the switching frequency ensures that harmonics at this frequency are filtered (i.e. strongly attenuated).

In the example illustrate in FIG. 4, the filter 40 has a resonant frequency of 10 KHz, the running frequency of the motor 10 is around 2 kHz, and the switching frequency of the motor 10 is around 20 KHz. It can be seen in FIG. 4 that the impedance of the filter is around 45 Ohms at the running frequency, around 4 Ohms at the resonant frequency, and around 14 Ohms at the switching frequency. In employing a resonant frequency of 10 kHz, the filter 40 provides relatively weak attenuation of harmonics at the running frequency (2 kHz) and its second order (4 kHz), whilst providing relatively strong attenuation of harmonics at the switching frequency (20 kHz) and its second order (40 kHz).

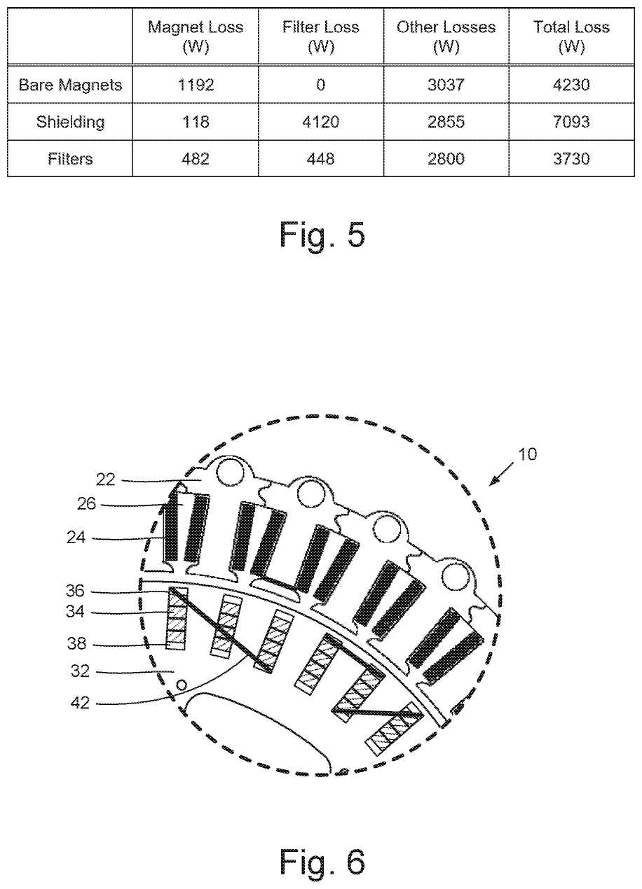

FIG. 5 details the power losses for an example motor having bare magnets, shielding, and filters. The ‘Other Losses’ in FIG. 5 refer to all other power losses within the motor, e.g. rotor iron loss, stator iron and copper losses, windage and bearing losses. It can be seen that, in comparison to bare magnets, the magnet loss is more than halved when employing the magnetic low-pass filters (482 W vs 1192 W). Although there are additional filter losses, the total power loss is nevertheless reduced (from 4230 W to 3730 W). It can be further seen that, in comparison to shielding, the magnet loss is slightly higher when employing the filters (482 W vs 118 W). However, the magnet loss continues to be relatively low and thus excessive heating of the magnets is avoided. Notably, the filter loss is almost a tenth (448 W vs 4120 W) and the total power loss is almost half (3730 W vs 7093 W) when employing the filters.

Each of the magnets 34 is segmented (either fully or partially) and comprises a plurality of magnet segments. By segmenting the magnets 34, the electrical resistance of each magnet 34 is increased. As a result, the magnet loss is further reduced due to the lower eddy currents induced by the lower frequency harmonics. Segmentation, however, increases the surface area of each of the magnets 34. Consequently, in the absence of the filters 40, segmentation may actually result in a higher magnet loss due to the skin effect at higher harmonic frequencies. By employing magnetic low-pass filters 40, the relatively high harmonic frequencies that might otherwise present a problem can be filtered. A synergistic effect is therefore achieved in employing a magnetic low-pass filter together with a segmented magnet. In particular, the magnetic low-pass filter filters higher frequency harmonics but passes lower frequency harmonics, and segmentation of the magnet reduces eddy currents at lower frequency harmonics. As a result, a net reduction in power loss may be achieved. Segmentation may be employed with bare magnets in order to reduce magnet loss. However, by employing the magnetic low-pass filter, the same reduction in magnet loss may be achieved with a lower degree of segmentation (i.e. fewer magnet segments). Segmentation is not, however, without its disadvantages (e.g. waste magnetic material, bonding of the segments, machining the bonded segments to achieve the desired shape). Accordingly, in spite of the aforementioned advantages, the magnets 34 need not be segmented.

In the embodiment described above, a filter 40 is provided for each of the magnets 34. Moreover, the coil 42 of each filter 40 is wound about a respective magnet 34. This then has the advantage that the filter 40 links to and filters the stator flux that links with the magnet 34, but does not link to other stray fluxes. As a result, effective protection to the magnets may be provided without additional, unnecessary losses in the filter 40.

In winding the coil 42 about the magnet 34, the coil 42 may be in thermal contact with the magnet 34. However, as is evident from FIG. 5, there is a net reduction in the sum of the magnet and filter losses. Consequently, even if the coil 42 is in thermal contact with the magnet 34, the magnet 34 will nevertheless be cooler than if the magnet were bare or shielded. Moreover, the coil 42 is likely to have a higher thermal conductivity than the magnet 34. The coil 42 may therefore be used to conduct heat away from the magnet 34. For example, the motor 10 may include a coolant system that exchanges heat with the coil 42.

In spite of the aforementioned advantages, the coil 42 of each filter 40 need not be located around a respective magnet 34. Moreover, the motor 10 need not comprise a filter 40 for each magnet 34. The coil 42 of the filter 40 need only be linked with the stator flux such that the filter 40 is able to filter high frequency harmonics in the stator flux. Accordingly, the coil 42 may be located elsewhere on the rotor 30 or indeed on the stator 20. By way of example, FIG. 6 illustrates four alternative locations for the coil 42 (shown in heavy line); three on the rotor 30 and one on the stator 20.

Whilst the filter 40 may be mounted to the stator 20, there are advantages in mounting the filter 40 to the rotor 30. By mounting the filter 40 to the rotor 30, the filter 40 rotates synchronously with the rotor 40 and therefore with the magnet flux, as well as the fundamental stator flux. The filter 40 does not therefore interact with these fluxes. By contrast, if the filter 40 were mounted to the stator 20, the filter 40 would interact with these fluxes. As a result, the filter loss would be higher. Nevertheless, there may be scenarios where it is desirable to locate the filter 40 on the stator 20. For example, the rotor 30 of the motor 10 may be relatively simple, making it different to physically locate the filter 40 on the rotor 30. For example, the rotor 30 may comprise a cylindrical magnet secured to a shaft, with no additional rotor core. In this instance, the filter 40 may be mounted to the stator 20, with the coil 42 wound about a tooth or pole of the stator 20.

Each of the filters 40 is a passive, second order filter comprising a coil 42 and a capacitor 44. As a result, high frequency harmonics in the stator flux may be filtered in a relatively simple and cost-effective manner. In particular, high frequency harmonics may be attenuated using a filter that is unpowered and has a relatively large frequency range. Nevertheless, alternative types of magnetic low-pass filter may be employed, including higher order and/or active filters.

Whilst particular examples and embodiments have thus far been described, it should be understood that these are illustrative only and that various modifications may be made without departing from the scope of the invention as defined by the claims. For example, whilst the motor described above and illustrated in the Figures is an interior permanent magnet motor having an inner rotor, the provision of a magnetic low-pass filter may be employed with other types of motor, particularly but not exclusively permanent magnet motors. By way of example, the magnetic low-pass filter may be employed in a motor that does not comprise permanent magnets. In this instance, the filter continues to attenuate high frequency harmonics in the stator flux linked to the rotor. As a result, a reduction in rotor loss and/or torque ripple may be achieved. Alternatively, a similar rotor loss may be achieved using a cheaper, more lossy rotor core (e.g. cheaper, more lossy laminations).

1. An electric motor comprising:
a rotor;
a stator comprising a stator core and windings; and
a magnetic low-pass filter comprising a coil having one or more turns and one or more capacitors connected in series with the coil,
wherein excitation of the windings generates stator flux, the coil is linked to the stator flux, and the filter attenuates harmonics in the stator flux.

2. The electric motor as claimed in claim 1, wherein the rotor comprises one or more magnets.

3. The electric motor as claimed in claim 1, wherein the filter has a resonant frequency greater than a running frequency of the motor.

4. The electric motor as claimed in claim 3, wherein the resonant frequency is at least twice that of the running frequency.

5. The electric motor as claimed in claim 3, wherein an impedance of the filter at the running frequency is at least ten times an impedance of the filter at the resonant frequency.

6. The electric motor as claimed in claim 1, wherein the filter has a resonant frequency less than a switching frequency of the motor.

7. The electric motor as claimed in claim 6, wherein an impedance of the filter at the switching frequency is no more than five times an impedance of the filter at the resonant frequency.

8. The electric motor as claimed in claim 1, wherein an impedance of the filter at a running frequency of the rotor is at least three times an impedance of the filter at a switching frequency of the windings.

9. The electric motor as claimed in claim 1, wherein the filter is mounted to the rotor.

10. The electric motor as claimed in claim 1, wherein the rotor comprises one or more magnets, and each magnet is segmented and comprises a plurality of magnet segments.

11. The electric motor as claimed in claim 1, wherein the rotor comprises one or more magnets, and the electric motor comprises a filter for each magnet.

12. The electric motor as claimed in claim 11, wherein the coil of the filter is wound about the magnet.

13. The electric motor as claimed in claim 1, wherein the capacitors are located within a cavity in one of the rotor and the stator.

14. The electric motor as claimed in claim 13, wherein the filter comprises a plurality of capacitors located along a length of the cavity.

15. The electric motor as claimed in claim 1, wherein the filter is passive.
